(19) United States
(12) Patent Application Publication
(10) Pub. No.: US 2012/0030316 A1
(43) Pub. Date: Feb. 2, 2012

(54) Unified Media Content Directory Services

(75) Inventors: James F. Dougherty, Morgan Hill, CA (US); Reinhard R. Steffens, Santa Clara, CA (US); Thomas J. Zato, Santa Clara, CA (US); Sheng Qu, San Jose, CA (US)

(73) Assignee: DOLBY LABORATORIES LICENSING CORPORATION, San Francisco, CA (US)

(21) Appl. No.: 13/255,328

(22) PCT Filed: Apr. 20, 2010
(86) PCT No.: PCT/US10/31769

§ 371 Date: Sep. 8, 2011

Related U.S. Application Data
(60) Provisional application No. 61/172,628, filed on Apr. 24, 2009.

(51) Int. Cl. G06F 15/16

(52) U.S. Cl. 709/219

(57) ABSTRACT

A unified media content directory may be created for multiple computing devices that store media content. These computing devices may be in the same network domain or span across different network domains. These computing devices may provide their media content through the unified media content directory based in part on standard technologies. A client that has a limited security permission may be able to access the unified media content directory and the media content identified in the unified media content directory in an intuitive, consistent manner, no matter where the client may be located, assuming the client has adequate digital rights for the media content the client. Additionally, load conditions of the media content servers may be monitored. A load balancing algorithm and high availability for accessing a piece of media content may be provided, if the media content can be accessed through more than one media content server.

### CROSS-REFERENCE TO RELATED APPLICATION AND PRIORITY CLAIM

This application is related and claims priority to and benefit of co-pending U.S. Provisional Application No. 61/172,628, filed Apr. 24, 2009, by James F. Dougherty, Reinhard R. Steffens, Thomas J. Zato, and Sheng Qu, entitled UNIFIED MEDIA CONTENT DIRECTORY SERVICES, and assigned to the Assignee of the present Application. This application is hereby incorporated by reference in its entirety.

### TECHNOLOGY

The present invention relates generally to media, and in particular, to accessing media content in various media content servers.

### BACKGROUND

Media content such as audio, video, photos, etc., is often scattered among many different media content servers accessible via a communication network such as a LAN, WAN, an internet, the Internet, etc. Examples of these different media content servers include, but are not limited to, an audio player that plays music, a wireless communication device that contains functions to consume or store audio media content, video media content, photos, etc., or a web server on which media content is stored for client devices to access over the internet. Nowadays, an individual user may own several media content servers in the form of a laptop computer, USB device, digital camera, A/V player, etc., on which a variety of media content in diverse forms are stored.

Under some approaches, to access a particular piece of media content, a user must, based on personal knowledge, locate a specific media content server through which the particular media content can be accessed. Thus, if the user had two media content servers on which the particular media content may be stored, the user would have to know specifically which media content server has the particular media content, unless the particular media content has been duplicated to both media content servers. Sometimes, even if a user knows which specific media content server to use, the user still may not be able to correctly operate that specific media content server (e.g., a VCR with a relatively primitive and difficult man-machine interface). The situation can worsen if the user has many media content servers, or if media content is prone to be moved from one media content server to another, or if a media content server (e.g., a laptop) itself is prone to be moved (e.g., from home to office, café, etc.). This results in an inefficient operating model of having to know specific locations of media content and operational procedures of corresponding media content servers in order to access the media content. Thus, to many users, this inefficient operating model may not work well, if it works at all.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 depicts an example media content network, according to a possible embodiment of the present invention;

FIG. 2 illustrates an example possible embodiment in which example clients may access the unified media content directory service, according to a possible embodiment of the present invention;

FIG. 3 illustrates an example media content sharing domain that supports the unified media content directory service, according to a possible embodiment of the present invention;

FIG. 4 illustrates an example media content server that supports the unified media content directory service, according to a possible embodiment of the present invention;

FIG. 5 illustrates an example process flow that supports the unified media content directory service, according to a possible embodiment of the present invention; and

FIG. 6 depicts an example computer system platform, with which a possible embodiment of the present invention may be implemented.

### DESCRIPTION OF EXAMPLE EMBODIMENTS

Example possible embodiments, which relate to unified media content directory services, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily including, obscuring, or obfuscating the present invention.

The selection of an example domain, network, media content servers, media content and clients in this description may be made for simplicity and concise unity and, unless expressly stated to the contrary, should not be construed as limiting a possible embodiment to any particular domain, network, media content servers, media content and clients. In particular, possible embodiments of the present invention are well suited to function with media content in the form of video, video and other multimedia, and with media content servers in the form of graphical and other computing devices, or a system comprising these devices. Possible embodiments of the present invention are also well suited to function with a media content server in the form of one or more computing devices that display video and graphical information that may be oriented in two or three spatial dimensions.

Example possible embodiments are described herein according to the following outline:
1.0 General Overview
2.0 Functional Overview
   2.1 EXAMPLE MEDIA CONTENT NETWORK
   2.2 UNIFIED MEDIA CONTENT DIRECTORY
   2.3 DISCOVERING MEDIA CONTENT SERVERS
   2.4 EXAMPLE DUPLICATED DISTRIBUTION OF MEDIA CONTENT
   2.5 DISCOVERING OTHER MEDIA CONTENT SERVERS ON A PIECE OF MEDIA CONTENT NETWORK
   2.6 BROWSING INDIVIDUAL MEDIA CONTENT DIRECTORIES
   2.7 CREATING A UNIFIED MEDIA CONTENT DIRECTORY
   2.8 EXAMPLE CLIENTS
   2.9 EXAMPLE MEDIA CONTENT SHARING DOMAIN
   2.10 LOAD CONDITIONS
   2.11 ALTERNATIVE ORGANIZATIONS IN MEDIA CONTENT DIRECTORIES
   2.12 GROUPING ICONS THAT REPRESENT MEDIA CONTENT
   2.13 AUTHENTICATION AND DIGITAL RIGHTS
   2.14 LOAD BALANCING AND HIGH AVAILABILITY
   2.15 EXAMPLE MEDIA CONTENT SERVER
   2.16 EXAMPLE PROCESS FLOW
3.0 EXAMPLE IMPLEMENTATION PLATFORMS
4.0 ENUMERATED EXAMPLE EMBODIMENTS
5.0 EQUIVALENTS, EXTENSIONS, ALTERNATIVES AND MISCELLANEOUS

### 1.0 General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

In accordance with a possible embodiment of the present invention, a unified media content directory representing a media-centric view for divergent collections of media content on media content servers (e.g., computing devices through which the media content can be accessed) can be provided by the media content servers, thereby enabling a user to access, in an intuitive, consistent manner, the media content wherever located. In some possible embodiments, the media content servers where the media content can be accessed may form a whole, or a part of a communication network. In some possible embodiments, clients (e.g., media consuming devices) that access the media content in the unified media content directory are in the same communication network as the media content servers. In some possible embodiments, this communication network may be the Internet in which the media content servers and the clients may be located in different sub-networks (USB, Firewire, LAN, WAN, VPN, Intranet, Extranet, etc.) physically and/or logically.

In some possible embodiments, the unified media content directory can be implemented on the media content servers using standard-based technologies such as mDNS, DNS-SD, or HTTP. Particularly, even if a client such as a laptop may be at a different location from those of the media content servers, the client is still enabled to access the media content stored on the media content servers through a standard mechanism provided by these standard-based technologies. In some possible embodiments where access by a client to the media content on a media content server can be made with HTTP get requests, no special firewall settings need to be configured on either the client or the media content server, so long as a gateway that supports HTTP permits HTTP access to the media content server.

In some possible embodiments, a media content server identifies one or more media content servers that support a unified media content directory. To identify the plurality of media content servers, the media content server 104-1 may use a service discovery process such as DNS-SD, which allows the media content server 104-1 to receive one or more service announcements from the one or more media content servers.

In some possible embodiments, the media content server 104-1 retrieves, from each of the one or more media content servers, an individual media content directory. The one or more media content servers may belong to a single network domain such as an IP domain, or may span more than one network domains. Each of the one or more media content servers may run an HTTP server. The HTTP-based service provided by the HTTP server may be advertised in service announcements to other media content servers. Thus, using a suitable network protocol such as HTTP, the media content server 104-1 may retrieve individual media content directories from the media content servers. For example, the media content server may send one or more HTTP requests to each of the one or more media content servers. In response to the requests from the media content server, each of the one or more media content servers may send one or more HTTP responses to the media content server. These responses may contain information about the first individual media content directory.

In some possible embodiments, some HTTP requests, sent by the media content server, may be enhanced HTTP get requests. These enhanced requests may specify wildcard expressions to retrieve URLs that match the wildcard expressions. Enhanced HTTP get requests may be used to browse the individual media content directories, which for example, may or may not have a hierarchical organization in which URLs for media content may be in any of two or more levels in the hierarchical organization.

Based on the individual media content directories, the media content server creates a unified media content directory for the media content servers. Each URL in the unified media content directory refers to a distinct piece of media content. In some possible embodiments, at least one URL in the unified media content directory refers to an audio file. In some possible embodiments, at least one URL in the unified media content directory refers to a video file. In some possible embodiments, at least one URL in the unified media content directory refers to a digital photo file. In some possible embodiments, at least one URL in the unified media content directory refers to a media file that contains metadata, which can be used to uniquely identify a piece of media content contained therein.

The unified media content directory provides a uniform way for a client to access any piece of media content referred to by the URLs in the unified media content directory.

In some possible embodiments, once a unified media content directory is created on the media content server, a client may access a piece of media content referred to by a URL in the unified media content directory. In some possible embodiments, the media content server may receive, from a client, a request to access a piece of media content referred to by a URL in the unified media content directory. This request may be based on the standard HTTP protocol, for example. Upon receiving the request, the media content server may allow the client to access the piece of media content. In some possible embodiments, to consume the media content, the client may be required to present evidence of requisite digital rights.

In some possible embodiments, a piece of media content can be accessed through more than one media content server. In these possible embodiments, a load-balancing algorithm (least-loaded, round-robin, weighted round-robin, sequential, random, etc.) may be used to select a media content server among the more than one media content servers. The selected media content server can be used to provide the piece of media content to a requesting client. In some possible embodiments, the media content server may determine at some point in time that the selected media content server is out of service or overloaded. In response to such a determination, the media content server may replace the selected media content server with a new media content server as the media content server to provide access to the piece of media content.

As used herein, the term “media content server” refers to any device that is configured to provide access to media content in connection with a unified media content directory. Types of media content servers include a home PC, a laptop, a wireless device, an iPod, Zune, a desktop computer, a workstation, a set-top box, a digital camera, a video recorder, etc. For example, a home PC may be operatively connected to a number of home-based devices. The home PC may be able to access various pieces of media content whose copies are in various locations and connected devices. One of these pieces of media content may be a photographic image. A digital file of the photographic image, which may be stored on a SSD that is attached to the home PC, constitutes a copy of the piece of media content (photographic image). To provide access by clients to the photographic image, an HTTP server may be implemented on the home PC. Even though the HTTP directory of the HTTP server is physically created on a “C” drive of the home PC, not on the file system of the SSD on which the digital copy of the photographic image is located, a resource locator in an individual media content directory of the home PC may nevertheless be logically configured to point to the digital copy of the photographic image. For example, a URL in an HTTP directory “content” in the home PC may point to the digital file on the SSD. This URL may be provided by the home PC to a media content server when the media content server browses and traverses the individual media content directory of the home PC (using HTTP get requests and responses). The media content server may configure its own local URL in a unified media content directory to point to the URL of the home PC. As a result, after providing the local URL in the unified media content directory, a client may use the local URL in the unified media content directory to access the digital file of the photographic image.

### 2.0 Functional Overview

### 2.1 Example Media Content Network

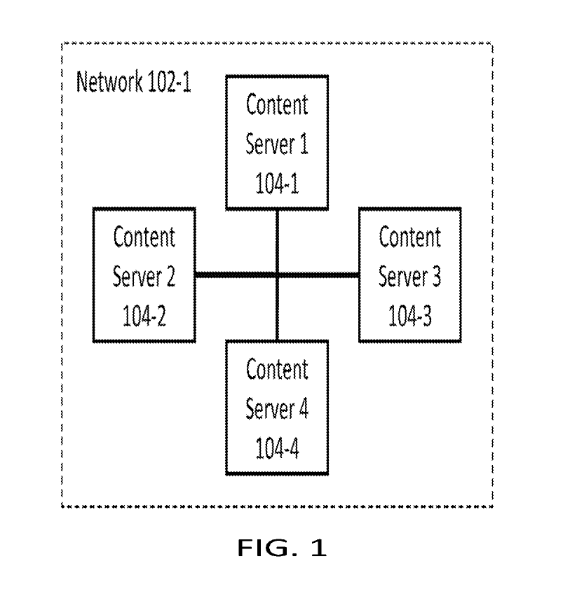

According to a possible embodiment, as illustrated in FIG. 1, a media content network (e.g., 102-1) comprises one or more media content servers (e.g., 104-1 through 104-4 as shown). As used herein, a media content network may be any network that comprises a plurality of networking devices at least some of which provides media content for clients to access. Multiple pieces of media content may be stored on each media content server. As used herein, the term “a piece of media content” refers to an original expression (such as a speech, an episode, a song, an article, a paragraph, a photo, a video clip, a movie, a scene, a book, a markup language component or file, a particular arrangement of data elements, etc., or a part thereof) that can be affixed or stored on at least one tangible medium (e.g., paper, tape, hard drive, RAM, SSD, etc.). The original expression on a tangible medium may be rendered in such a form that the original expression can be reproduced, replayed, distributed, performed, read, heard, or otherwise perceived by a human or a machine such as a set-top box, a TV, a computer, etc.

For the purpose of this invention, when the original expression is affixed or stored on a tangible computer-readable medium, a copy of the media content is created. As used herein, the term “a media content is stored on a media content server 104-1” means that a copy of the media content is stored/affixed in a tangible computer-readable medium (which, for example, is communicatively coupled to, or is a part of, the media content server 104-1) such that the media content server 104-1 is configured to access/fetch the media content or the copy thereof from the tangible computer-readable medium. Examples of tangible computer-readable media on which original expressions can be affixed or stored include, but are not limited to, random access memory, read-only memory, an optical disc, a hard drive, flash memory, an SSD, a peripheral device attached to the media content server 104-1, and/or a storage device.

Examples of copies of a piece of media content include, but are not limited to, media files, records, objects, and data containers that contain data to be accessed by clients. For example, a copy of a piece of media content may contain audio data, video data, or related metadata.

As used herein, the term “a media content server provides a piece of media content to a client” means that the media content sever provides the piece of media content in the form of a particular arrangement of data elements (e.g., bits, bytes, double-bytes, etc.) to the client such that a copy of the piece of media content, or a copy of a part of the piece of media content, may be created from the particular arrangement of data elements or that the piece of media content or a part of the piece of media content may be rendered in such a form from the particular arrangement of data elements that the piece of media content can be reproduced, read, heard, or otherwise perceived.

### 2.2 Unified Media Content Directory

Some pieces of media content may be stored on more than one media content server 104-1. For example, copies of the same piece of media content such as a song may be stored on both an iPod and a Zune (both of which are examples of media content servers 104).

In some possible embodiments, even though copies of multiple pieces of media content may be stored on more than one media content server 104-1 in variable numbers, each of the media content servers 104 still provides to clients a unified media content directory. The term “unified media content directory” refers to a unified, media-centric view of multiple pieces of media content stored on the media content servers 104. Instead of providing a device-centric view in which a collection of media content is separately organized under individual media content servers on which the media content respectively resides, the unified media content directory as described herein provides a directory of unique pieces of media content no matter where these pieces of media content are located or how many copies of a unique piece of media content exist on the media content servers 104. In other words, even if multiple copies of a distinct piece of media content may be stored on more than one media content server 104-1, or even if a distinct piece of media content may be accessed through more than one media content server 104-1, the unified media content directory comprises only one resource locator for such a distinct media content.

As used herein, the term “a distinct piece of media content” refers to a piece of media content that is distinct from all other pieces of media content that are referred to in the unified media content directory; two pieces of media content are distinct if their underlying original expressions are different.

In some possible embodiments, each distinct piece of media content has a distinct name. For example, copies of a piece of media content A may have a name A, while copies of a piece of media content B may have a name B. If the name A (e.g., Mv1_Sc1.mp4) is different (distinct) from the name B (e.g., Mv1_Sc2.mp4), then the piece of media content A will be different (distinct) from the piece of media content B. Conversely, if the piece of media content A is different from the piece of media content B, then the name A will be different from the name B. On the other hand, in these possible embodiments, if the name A (e.g., Mv1_Sc1.mp4) is the same as the name B (e.g., Mv1_Sc1.mp4), then the piece of media content A is the same as the piece of media content B (e.g., a copy of the piece of media content A and a copy of the piece of media content B are copies of the same underlying media content). Conversely, if the piece of media content A is the same as the piece of media content B, then names of copies of the piece of media content A are the same as names of copies of the piece of media content B also.

In other possible embodiments, different pieces of underlying media content may have copies that use duplicate names. For example, even if a piece of media content C is different from a piece of media content D, the name for the piece of media content C may be the same as the name for the piece of media content D in these other possible embodiments. In a particular possible embodiment of these embodiments, a copy of a piece of media content may comprise metadata such as a message digest that can be used to (intrinsically) distinguish one from others among different pieces of underlying media content. For example, MD5 signatures computed from portable digital representations of multiple pieces of media content may be stored in metadata of copies of these pieces of media content. Based on these MD5 signatures in the metadata, logic may be implemented, for example in a media content server 104-1 or in a client, to determine whether two copies of media content pertain to two distinct pieces of media content, or to a single piece of underlying media content. Thus, in these possible embodiments, even if names of copies of different pieces of media content may be arbitrary and duplicated, logic may be implemented, for example by a client or a media content server 104-1, to determine, based on metadata in the copies of these different pieces of the media content, whether the pieces of media content are indeed the same or different.

### 2.3 Discovering Media Content Servers

In some possible embodiments, every media content server 104-1 in the media content network 102-1 is assigned a unique network address such as an IP address. In a particular possible embodiment of these embodiments, a user, or a configuration agent running on a media content server 104-1, may assign a network address to the media content server. Alternatively and/or additionally, a network address may be assigned to a media content server 104-1 dynamically using suitable network protocols. For example, Dynamic Host Configuration Protocol (DHCP as described in RFC 2131) and/or Dynamic Configuration of IPv4 Link-Local Addresses (as described in RFC 3927) may be used to perform dynamic assignment of addresses to some, or all, of the media content servers 104.

In some possible embodiments, each media content server in the media content network 102-1 runs an HTTP server. When a media content server 104-1 receives a request for providing media content stored on the media content server 104-1, this request may be an HTTP-based request (e.g., an HTTP get request) and can be handled and responded in the same protocol by the HTTP server in conjunction with other logic implemented thereon.

In some possible embodiments, a media content server 104-1 in the media content network 102-1 makes service announcements to other media content servers 104, informing the other media content servers 104 that the media content server 104 supports the unified media content directory service. In a particular possible embodiment of these possible embodiments, a service announcement informs the other media content servers 104 that the support for this unified media content directory service on a media content server 104-1 is provided based on the HTTP protocol implemented by the HTTP server previously described. The service announcements may be made to any device on the media content network 102-1 through suitable networking protocols. In a possible embodiment, service announcements may be made using multicast Domain Name Service (mDNS; as described in draft-cheshire-dnsext-multicastdns-07.txt authored by Stuart Cheshire et al.) and Domain Name Service-Service Discovery (DNS-SD; as described in draft-cheshire-dnsext-dns-sd-05.txt by Stuart Cheshire et al.). In some possible embodiments, a service announcement is a multicast message (e.g., a data packet as defined by DNS-SD) containing a record with name-value pairs to identify a number of fields and corresponding values for the fields related to the announced service.

In some possible embodiments, a service announcement as mentioned above may comprise a record with some, or all, of the following fields:
name—the name of the media content server 104-1 (e.g., James's iPod)
ip—the network address (address used in OSI layer-3 such as IP) of the media content server 104-1
srv—the mDNS service type (e.g., _http._tcp_)
port—the HTTP service port (e.g., 80)
dir—the HTTP directory in which media content can be accessed through the HTTP server on the media content server 104-1 using, for example, HTTP get requests.
load—an indicator, e.g., an integer from 1 to 100, which indicates the load condition of the media content server 104-1, for example, at the time of the service announcement.

In some possible embodiments, a media content server 104-1 starts making service announcements when it starts up or when it obtains the first assignment of the network address. Thereafter, service announcements may be made by the media content server 104-1 from time to time, for example, on demand from another media content server (e.g., 104-2), periodically, as scheduled, or with a frequency that can be adjusted by the media content server 104-1 based on one or more factors including whether and how frequently the media content on the media content server 104-1 are changed and so on.

In some possible embodiments, based on the service announcements received from other media content servers 104 in the media content network 102-1, a media content server 104-1 may compile a list of the media content servers in the media content network 102-1, including the media content server 104-1. In some possible embodiments, this list may comprise a load indicator for each media content server. In some possible embodiments, this load indicator may be derived from the “load” field in the service announcements. In some other possible embodiments, this load indicator may be set based on information derived from proactive probing by each media content server that compiles the list. This list may be stored as a file (e.g., /tmp/http-hosts) on the media content server 104-1. Thus, even if the media content server 104-1 restarts or awakens from sleep, the media content server 104-1 may still obtain the list of the media content servers 104 from the stored file as a starting point. The media content server 104-1 may update this list when any stored information in the list is determined as outdated, incorrect, or incomplete. For example, when a media content server 104-1 is terminated or announces that the media content server 104-1 is withdrawing from supporting the unified media content directory service, other media content servers 104 may update their lists of media content servers accordingly. In some possible embodiments, to reduce tampering by intruders, a privileged user such as the root of the media content server 104-1 may own the file.

### 2.4 Example Duplicated Distribution of Media Content

As noted before, various copies of various pieces of media content may be stored in the media content servers 104 in the media content network 102-1. For the purpose of illustration only, the media content servers 104 may collectively store the media content of a movie. The movie may be made up of ten different scenes. Each of the ten different scenes constitutes a distinct piece of media content. In some possible embodiments, each distinct piece of media content (in this example, each different scene) may be stored as a multimedia file. For example, the first scene may be stored as Mv1_Sc1.mp4; the second scene may be stored as Mv1_Sc2.mp4; and so on. For the purpose of illustration only, copies of the ten scenes of the movie may be distributed/stored on the media content servers 104 as follows:

| 104-1 | 104-2 | 104-3 | 104-4 |
|---|---|---|---|
| Mv1_Sc1.mp4 | Mv1_Sc5.mp4 | Mv1_Sc6.mp4 | Mv1_Sc4.mp4 |
| Mv1_Sc2.mp4 | Mv1_Sc1.mp4 | Mv1_Sc2.mp4 | Mv1_Sc9.mp4 |
| Mv1_Sc3.mp4 | Mv1_Sc7.mp4 | Mv1_Sc8.mp4 | Mv1_Sc10.mp4 |

As can be seen, the first scene has two copies (Mv1_Sc1.mp4) stored on both the media content server 104-1 and the media content server 104-2. Similarly, the second scene has two copies (Mv1_Sc2.mp4) stored on both the media content server 104-1 and the media content server 104-3.

In some possible embodiments, one or more pieces of media content stored on a media content server 104-1 are configured for HTTP-based access under a particular directory of the above-described HTTP server, no matter where these pieces of media content may actually be scattered in different storage locations on the media content server 104-1. For example, even if the multimedia files “Mv1_Sc1.mp4”, “Mv1_Sc2.mp4”, and “Mv1_Sc3.mp4” may be in different file system directories or USB drives on the media content server 104-1, these multimedia files may nevertheless be configured as accessible through the HTTP server on the media content server 104-1 under a particular HTTP directory. In some possible embodiments, this HTTP directory may be configured to be http://ip:port/dir/, where ip, port and dir are the fields of the previously described service announcement. In some possible embodiments, the “dir” fields for all the media content servers 104 on the media content network 102-1 are of the same string value “content” (thus, in a particular possible embodiment, since all the media content servers 104 configure their respective media content in the “content” directories, the “dir” field may be safely omitted from the previously described service announcements). In some possible embodiments, the value for the “dir” field on a media content server 104-1 may be manually or programmatically configured. In some other possible embodiments, this “dir” field value may also be hard-coded in the software implementing new techniques described herein, which has been deployed on the media content server 104-1.

For the purpose of illustration only, the media content server 104-1 may be a media player capable of consuming movie-type media content. Mv1_Sc1.mp4 may be on a USB storage attached to the media content server 104-1. Mv1_Sc2.mp4 may be on the flash memory as a part of the media content server 104-1. Mv1_Sc3.mp4 may be on a different computing device communicatively coupled to the media content server 104-1. To allow a client to access any of movie scenes that are scattered in different media locations based on an access protocol such as HTTP, copies of one or more movie scenes on the media content server 104-1 are all configured under the particular HTTP directory with a URL “http://10<dot>203<dot>1<dot>45/content/”, where 10<dot>203<dot>1<dot>45 is the IP address of the media content server 104-1 (for the purpose of illustration, <port> is defaulted to 80; hence it can be omitted from the URL).

### 2.5 Discovering Other media Content Servers on a Media Content Network

As used herein, the term “unified media content directory service” refers to providing a previously described unified media content directory to a client and allowing the client to access a media content in the unified media content directory no matter where the media content is physically located. It should be noted that the term “a media content server 104-1 supports unified media content directory service” refers to an ability to enter into an agreement with other media content servers 104 to provide a unified media content directory service while the term “a media content server 104-1 provides unified media content directory service” means that such an agreement has been reached and that clients can retrieve a unified media content directory and media content as referred to by resource locators therein from the media content server 104-1. In some possible embodiments, the agreement to provide the unified media content directory service may be reached by the media content servers 104 in the media content network 102-1, after the media content servers 104 have all made their service announcements. When the agreement is reached, the media content servers 104 as a whole have reached a state in which a unified media content directory can be created and media content as referred to by resource locators therein can be offered to clients for access.

The provision of the unified media content directory service on each media content server may be implemented by one or more processes that work in conjunction with the HTTP server on the media content server 104-1 or by one or more modules that are implemented in the HTTP server. However implemented, the unified media content directory service may monitor the list of media content servers 104 available on the media content network 102-1. For example, the unified media content directory service may monitor the previously described “/tmp/http-hosts” file to obtain the list of media content servers and the servers' load indicators. The unified media content directory service may read the file periodically or if it is determined that the file has been changed (for example, based on a “last modified” timestamp of the file).

### 2.6 Browsing Individual Media Content Directories

In some possible embodiments, the unified media content directory service sends one or more HTTP get requests to each of other media content servers 104 to retrieve an individual media content directory under the advertised “content” HTTP directory. These HTTP get requests cause the recipient media content server 104-1 to return responses that identify one or more pieces of media content under the HTTP directory “content” of the recipient media content server 104-1. It should be noted that, even without providing the unified media content directory service, the recipient media content server 104-1 may already provide access to the one or more pieces of media content whose URLs are listed in the individual HTTP directory (“content”).

In some possible embodiments, an individual media content directory of a media content server comprises one or more URLs, each URL representing an individual piece of media content on the media content server that is accessible by a client.

In a possible embodiment, all URLs that refer to the one or more pieces of media content are directly under the previously described HTTP directory, “http://<ip>:<port>/<dir>/”, where <dir> is “content” in the present example. For the purpose of illustration, the URLs for the one or more pieces of media content on the media content server 104-1 may be as follows:
http://10<dot>203<dot>1<dot>45/media content/Mv1_Sc1.mp4
http://10<dot>203<dot>1<dot>45/media content/Mv1_Sc2.mp4
http://10<dot>203<dot>1<dot>45/media content/Mv1_Sc3.mp4

In some possible embodiments, this holds true for other media content servers 104 in the media content network 102-1. Thus, in these possible embodiments, using standard HTTP get requests, each media content server may get URLs of media content stored on other media content servers 104 in the media content network 102-1.

### 2.7 Creating a Unified Media Content Directory

Based on the URLs of media content for all media content servers 104 in the media content network 102-1, the media content server 104-1 compiles an aggregated list of all URLs of media content, which clients may access through one or more of the media content servers 104 in the media content network 102-1. For example, an aggregated list of all URLs of media content may be as follows:
http://10<dot>203<dot>1<dot>45/media content/Mv1_Sc1.mp4
http://10<dot>203<dot>1<dot>45/media content/Mv1_Sc2.mp4
http://10<dot>203<dot>1<dot>45/media content/Mv1_Sc3.mp4
http://10<dot>203<dot>1<dot>90/media content/Mv1_Sc5.mp4
http://10<dot>203<dot>1<dot>90/media content/Mv1_Sc1.mp4
http://10<dot>203<dot>1<dot>90/media content/Mv1_Sc7.mp4
http://10<dot>203<dot>1<dot>135/media content/Mv1_Sc6.mp4
http://10<dot>203<dot>1<dot>135/media content/Mv1_Sc2.mp4
http://10<dot>203<dot>1<dot>135/media content/Mv1_Sc8.mp4
http://10<dot>203<dot>1<dot>180/media content/Mv1_Sc4.mp4
http://10<dot>203<dot>1<dot>180/media content/Mv1_Sc9.mp4
http://10<dot>203<dot>1<dot>180/media content/Mv1_Sc10.mp4
   where 10<dot>203<dot>1<dot>90, 135, 180, for the purpose of illustration, are IP addresses for the media content servers 104-2, 3, and 4, respectively.

To create a unified media content directory as previously described, the media content server 104-1 first removes duplicate pieces of media content in the aggregated list. In some possible embodiments, to remove duplicate pieces, a media content server such as 104-1 may make use of the load indicators in the list of media content servers (e.g., /tmp/http-hosts). For example, the media content server 104-1 may determine that scene 2 of the movie is duplicated on both the media content servers 104-1 and 104-3. The media content server 104-1 may determine that out of the two media content servers 104-1 and 104-3, the media content server 104-1 should provide the piece of media content as indicated by “Mv1_Sc2” based on a number of factors as will be further explained. Thus, the media content server 104-1 may eliminate the URL (for scene 2) from the media content server 104-3 from the unified media content directory that is to be provided by the media content server 104-1. This may be repeated for other duplicate or replicate media content found in the aggregated list of URLs.

As a result, a non-duplicate list of URLs for the media content stored on the media content servers 104 in the media content network 102-1 may be created, for example, as follows:
http://10<dot>203<dot>1<dot>45/content/Mv1_Sc1.mp4
http://10<dot>203<dot>1<dot>45/content/Mv1_Sc2.mp4
http://10<dot>203<dot>1<dot>45/content/Mv1_Sc3.mp4
http://10<dot>203<dot>1<dot>180/content/Mv1_Sc4.mp4
http://10<dot>203<dot>1<dot>90/content/Mv1_Sc5.mp4
http://10<dot>203<dot>1<dot>135/content/Mv1_Sc6.mp4
http://10<dot>203<dot>1<dot>90/content/Mv1_Sc7.mp4
http://10<dot>203<dot>1<dot>135/content/Mv1_Sc8.mp4
http://10<dot>203<dot>1<dot>180/content/Mv1_Sc9.mp4
http://10<dot>203<dot>1<dot>180/content/Mv1_Sc10.mp4

As shown, these URLs are scattered among different media content servers 104. In some possible embodiments, a media content server such as 104-2 reconfigures each URL in this non-duplicate list of URLs as a (local) resource in another HTTP directory of the HTTP server on the media content server 104-1. In a particular possible embodiment, this other HTTP directory has a URL “http://<ip>:<port>/<new_dir>/”, where <new_dir> may be set, for example, as “media” (as opposed to “content” in the service announcements). All the reconfigured URLs under this other HTTP directory makes up the unified media content directory as previously described for all the media content configured to be accessed by clients through the media content servers 104 in the media content network 102-1. For example, the unified media content directory on the media content server 104-1 may be as follows:

Example Unified Media Content Directory:
http://10<dot>203<dot>1<dot>45/media/Mv1_Sc1.mp4
http://10<dot>203<dot>1<dot>45/media/Mv1_Sc2.mp4
http://10<dot>203<dot>1<dot>45/media/Mv1_Sc3.mp4
http://10<dot>203<dot>1<dot>45/media/Mv1_Sc4.mp4
http://10<dot>203<dot>1<dot>45/media/Mv1_Sc5.mp4
http://10<dot>203<dot>1<dot>45/media/Mv1_Sc6.mp4
http://10<dot>203<dot>1<dot>45/media/Mv1_Sc7.mp4
http://10<dot>203<dot>1<dot>45/media/Mv1_Sc8.mp4
http://10<dot>203<dot>1<dot>45/media/Mv1_Sc9.mp4
http://10<dot>203<dot>1<dot>45/media/Mv1_Sc10.mp4

As shown, now every piece of the media content on the media content servers 104 has been reconfigured as a local URL under the “media” HTTP directory on the media content server 104-1. The default landing page for the HTTP server on the media content server 104-1 may be populated by information stored in the unified media content directory. For the purpose of illustration, the default landing page for the HTTP server on the media content server 104-1 may be accessed at “http://10<dot>203<dot>1<dot>45/index.html”. When a client accesses the HTTP server by entering an “http://10<dot>203<dot>1<dot>45” URL or a URL with a suitable host name for the media content server 104-1, the client may be given the landing page that is populated by information in the unified media content directory. For example, such a landing page may list all ten scenes for the movie with their URLs under the “media” directory, as shown in the above list.

Similarly, other media content servers 104 can create a unified media content directory similar to the one as shown for the media content server 104-1.

### 2.8 Example Clients

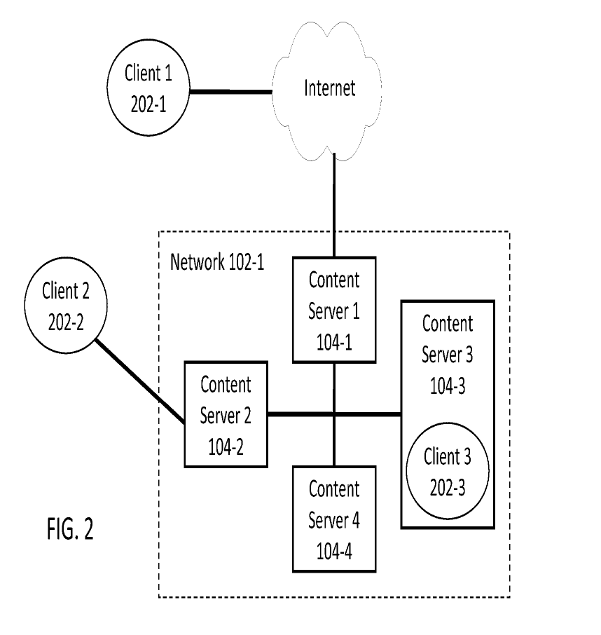

FIG. 2 illustrates an example possible embodiment in which example clients may access the unified media content directory service.

As shown, client 3 202-3 is implemented as a part of the media content server 3 104-3. In some possible embodiments, client 3 202-3 may access the landing page of the HTTP server on the media content server 104-3 as an HTTP client by issuing an HTTP get request at the URL “http://10<dot>203<dot>1<dot>135/index.html”. A unified media content directory, like the above example unified media content directory, may be displayed at a user interface of client 3 202-3. In a possible embodiment, the user interface may be implemented on a liquid crystal display on a wireless device that doubles as the media content server 104-3.

Using this landing page rendered and displayed on the user interface, client 3 202-3 can access a piece of media content whose URL is in the unified media content directory. For example, to access Mv1_Sc1.mp4, a user at client 3 202-3 may simply click on a URL “http://10<dot>203<dot>1<dot>135/media/Mv1_Sc1.mp4”. In some possible embodiments, since this URL is a reconfigured local URL from, for example, an original URL “http://10<dot>203<dot>1<dot>45/media content/Mv1_Sc1.mp4”, the HTTP server on media content server 104-3 may redirect the HTTP request to the original URL. As a result, an appropriate redirect HTTP request is sent to the media content server 104-1. Upon receiving this redirect HTTP request, the media content server 104-1 may provide an appropriate HTTP response, which may include, but is not limited to, starting a streaming session for Mv1_Sc1.mp4 between the media content server 104-1 and the client co-located with the media content server 104-3.

With the unified media content directory service, a client may access any media content in the unified media content directory in the same manner, no matter where the client is located, so long as the client is communicatively coupled to a suitable media content server 104-1. For example, the user at client 3 202-3 at some point may want to access Mv1_Sc6.mp4, which happens to be on media content server 104-3 according to the unified media content directory received by client 3 202-3. To access Mv1_Sc6.mp4, the user may simply click a corresponding URL in the unified media content directory, which generates an HTTP request of “http://10<dot>203<dot>1<dot>135/media/Mv1_Sc6.mp4”. In turn, a redirected HTTP request of “http://10<dot>203<dot>1<dot>135/media content/Mv1_Sc6.mp4” may be used to replace the HTTP request. The media content server 104-3, when handling the redirect HTTP request, may provide an appropriate HTTP response, which may include, but is not limited to, starting a local session for Mv1_Sc6.mp4 on the media content server 104-3.

A client may or may not be co-located with any media content server 104-1. In some possible embodiments, a client 2 202-2 may be a dedicated media consuming device that does not double as a media content server. In some possible embodiments, the client 2 202-2 may be on the same side of a corporate firewall with the media content network 102-1. In some possible embodiments, as long as client 2 202-2 is configured to be able to access at least one of the media content servers 104 in the media content network 102-1, client 2 202-2 is able to access all the media content in the media content servers 104 through the unified media content service. For example, client 2 202-2 may be configured to have an HTTP access at least to the media content server 104-2. Through this media content server 104-2, client 2 202-2 can obtain the landing page for the media content server 104-2. This landing page may contain URLs from a unified media content directory. Through this landing page, a user at client 2 202-2 may access any media content whose URL is in the unified media content directory in a similar manner as previously described in connection with client 3 202-3.

The unified media content directory service can be further provided to any client that has an HTTP access with any of the media content servers 104 in the media content network 102-1. For example, a client 1 202-1 may be operatively linked with the media content network 102-1 over an internetwork such as the Internet. Client 1 202-1 and the media content network 102-1 may be on opposing sides of a firewall. In some possible embodiments, as long as client 1 202-1 is configured to communicate with at least one of the media content servers 104 in the media content network 102-1, client 1 202-1 can be able to access all the media content in the media content servers 104 through the unified media content service. For example, client 1 202-1 may be configured to have an HTTP access to the media content server 104-1, which may serve as a gateway between the media content network 102-1 and the outside world in which client 1 202-1 resides. Through this media content server 104-1, client 1 202-1 can obtain the landing page for the media content server 104-1. This landing page may contain a unified media content directory. Through this landing page, a user at client 1 202-1 may access any media content in the unified media content directory, provided by all the media content servers 104 in the media content network 102-1, in a similar manner as previously described, with respect to client 3 202-3.

### 2.9 Example Media Content Sharing Domain

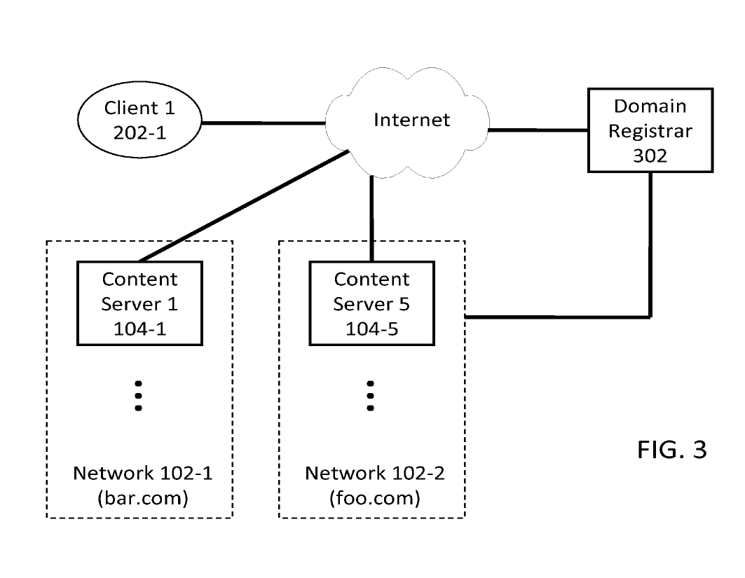

FIG. 3 illustrates an example media content sharing domain that supports the unified media content directory service according to a possible embodiment of the present invention. As used herein, a media content sharing domain may or may not correspond to an IP domain. In some possible embodiments, media content servers from one or more IP domains form a media content sharing domain. It should also be noted that even if a particular IP domain contributes one or more media content servers to a media content sharing domain, it does not follow that every computing device that is a member of the particular IP domain is a media content server for the media content sharing domain.

As shown, a media content network 102-1 may be in an IP domain “bar<dot>com”, while another media content network 102-2 may be in an IP domain “foe<dot>com”. Each of the two media content networks 102 of FIG. 3 may comprise its own set of media content servers and its own gateway that connects it to other networking devices such as client 1 (202-1 of FIG. 2 and FIG. 3). In some possible embodiments, these IP domains may be communicatively coupled with a domain registrar 302 over a network such as the Internet. For the purpose of illustration, as shown in FIG. 3, the gateway for the media content network 102-1 (which, for example, may be the media content network 102-1 of FIG. 2) is media content server 104-1, while the gateway for the media content network 102-2 is media content server 104-5.

In some possible embodiments, the domain registrar 302 provides a domain registration and lookup service for the unified media content directory service as provided by media content servers 104 in the media content sharing domain. Through this domain registration and lookup service, a media content network 102-1 may join or leave the media content sharing domain, and exchange media content directories with other media content networks 102 in the media content sharing domain.

In some possible embodiments, a networking device that is locally or remotely communicatively coupled to the domain registrar 302 may determine an IP address of a gateway of a media content network in the media content sharing domain. In some possible embodiments, the networking device may be able to browse all media content networks 102 (which may comprise more media content networks than the media content networks 102-1 and 102-2 as illustrated) that have been registered at the domain registrar 302 and to locate an IP address of a gateway of any of the registered media content networks.

For example, media content server 104-1, or another networking device, in the media content network 102-1 may send a request to the domain registrar 302 for the IP address of a gateway of another media content network 102-1 in the media content sharing domain. For the purpose of illustration, this gateway is media content server 104-5 of the media content network 102-2. Upon discovering the IP address of the gateway for the media content network 102-2, media content server 104-1 may request for a unified media content directory for the media content network 102-2. The unified media content directory for the media content network 102-2 may be provided by a media content server in the media content network 102-2 or by the domain registrar 302. This unified media content directory for the media content network 102-2 may be provided to other media content servers 104 on the media content network 102-1 by the media content server 104-1. In a particular possible embodiment, URLs from unified media content directories of other media content networks 102 may be reconfigured under one or more designated HTTP sub-directories (e.g., “stream”) under the previously discussed HTTP directory “media”. In some possible embodiments, names of the one or more designated HTTP sub-directories may be so chosen as to provide indicator information to clients where media content as referred to by URLs in these designated HTTP directories come.

In this manner, media content servers 104 in the media content network 102-1 may build a cross-network unified media content directory that encompasses all, or part, of media content provided by media content servers that are in media content networks that can be looked up using the domain registrar 302. In a particular possible embodiment, a global unified media content directory (e.g., a type of cross-network unified media content directory that encompass all media content networks in the media content sharing domain) may be built.

To access media content in media content servers in various media content networks 102 in the media content sharing domain, a client such as 202-1 of FIG. 3 may send a request to the domain registrar 302 for the IP address of a gateway of a media content network. Upon discovering the IP address of the gateway of the media content network 102-1, client 202-1 may request and obtain the landing page of the gateway. In a possible embodiment, this landing page may provide a global unified media content directory. In another possible embodiment, this landing page may provide a unified media content directory for the media content network 102-1. In some possible embodiments, in these alternative landings pages, one or more choices may be provided to client 1 202-1 to switch among available unified media content directories in various scopes. In this manner, client 1 202-1 may receive a unified media content directory that encompasses all, or part, of media content provided by media content servers in media content networks that can be looked up using the domain registrar 302. Based on the unified media content directory as provided on the landing page or another page that can be navigated to by client 1 202-1, client 1 202-1 can access a piece of media content in the unified media content directory in the same manner as previously described. For example, if a piece of media content is provided by a media content server 104-1 on a remote media content network 102-1, a redirection mechanism may be implemented on a gateway to reconfigure a remote URL for the piece of media content on the remote media content network 102-1 as its own URL in a unified media content directory provided to client 1 202-1 and to redirect a corresponding HTTP request from client 1 202-1 in the unified media content directory to the media content server 104-1 on the remote media content network 102-1, as appropriate.

### 2.10 Load Conditions

In some possible embodiments, in building a cross-network unified media content directory, a media content server may favor local media content on the same media content server over remote media content. A media content server may favor remote media content from the same media content network over remote media content from a different media content network.

Other policies and rules in building a unified media content directory may be configured manually or programmatically on a media content server. Several media content servers 104 may all be able to provide a piece of media content. In some possible embodiments, if all other things are equal, from which one of the several media content servers 104 a copy of the piece of media content is to be included in a unified media content directory may depend on the relative load conditions of these media content servers.

For example, if a piece of media content can be provided by several remote media content servers 104 on a media content network 102-1, then the copy of the piece of media content from the least loaded media content server may be chosen to be included in a unified media content directory. Similarly, if a piece of media content can be provided by media content servers 104 on several remote media content networks 102, then a copy of the piece of media content from the least loaded media content server from the several remote media content networks 102 may be chosen to be included in a (cross-network) unified media content directory.

As previously discussed, within the same media content network 102-1, service announcements for supporting unified media content directory service may carry indicators (e.g., the “load” field in the service announcements) for load conditions on media content servers 104. A range of numbers may be used to indicate a load condition on a particular media content server. Alternatively and/or optionally, logic can be implemented in a media content server to determine load conditions through other means. For example, a media content server may make remote procedure calls (e.g., rstat( ) call under UNIX-like operating systems) to obtain the load condition of another media content server. In addition, other calls or procedures such as traceroute and ping commands may be used to probe round trip response times, which may be taken into account as indicators of load conditions of remote media content servers 104. It should be noted that various other ways of obtaining load conditions of other media content servers in various other possible embodiments are within the scope of the present invention.

### 2.11 Alternative Organizations in Media Content Directories

It has been described that URLs of media content in an individual media content directory of a media content server 104-1 may be directly under an HTTP directory such as “content” of the HTTP server on the media content server 104-1. It should be noted that this is for illustration only. The present invention is not so limited. Other ways of organizing URLs of media content in an individual media content directory of a media content server 104-1 may be used. For example, URLs of media content may be under an HTTP directory with a different name from “content”. Additionally, even if URLs of media content are placed under an HTTP directory “content”, these URLs are not required to be directly under the HTTP directory “content”. Instead of placing all URLs directly under the HTTP director “content”, the URLs may be hierarchically organized under the HTTP directory “content”. For example, URLs for copies of different scenes of Movie 1 may be configured under a sub-directory “content/Movie1”, while other URLs for scenes in Movie 2 may be configured under a sub-directory “content/Movie2”. Thus, these and other variations of organizing URLs in an individual media content directory are within the scope of the present invention.

It has been described that URLs of media content in a unified media content directory as provided by a gateway or a media content server may be directly under an HTTP directory such as “media” of the HTTP server on the gateway or the media content server. It should be noted that this is for illustration only. The present invention is not so limited. Other ways of organizing URLs of media content in a unified media content directory may be used. For example, URLs of media content may be under an HTTP directory with a different name from “media”. Additionally, even if URLs of media content are placed under an HTTP directory “media”, the URLs are not required to be directly under the directory “media”. Instead of placing all URLs directly under the HTTP director “media”, the URLs may be hierarchically organized under some sub-directories of the HTTP directory “media”. For example, URLs for scenes of Movie 1 may be configured under a sub-directory “media/stream/mp4/Movie1”, while other URLs for scenes of Movie 2 may be configured under a sub-directory “media/download/mp4/Movie2”. Thus, these and other variations of organizing URLs in a unified media content directory are within the scope of the present invention.

To traverse an HTTP directory with a hierarchical organization, logic may be implemented on a media content server 104-1 to recursively explore the HTTP directory and its sub-directories at any level. In some possible embodiments, this logic uses regular HTTP get requests. For example, a first HTTP request may be sent by a first media content server 104-1 to a second media content server 104-1 to retrieve a first directory listing of the HTTP directory “content” on the second media content server 104-2. Once the first directory listing of the HTTP directory “content” is received in a HTTP response, the logic may determine whether any URLs in the first directory listing is itself a directory URL. If that is the case, a second HTTP request may be sent by the first media content server 104-1 to the second media content server 104-2 to retrieve a second directory listing under the directory as pointed to by the directory URL. In this manner, all URLs under the HTTP media content directory on the second media content server 104-2 may be retrieved using the standard HTTP get request.

In some possible embodiments, the HTTP server of a media content server 104-1 may implement an enhancement to the standard HTTP protocol. This enhancement allows the HTTP server to support a modified HTTP get request that contains wildcard specifications. In some possible embodiments, this enhancement to the standard HTTP protocol may be implemented on and supported by some, or all, of media content servers 104 in a media content network 102-1. Correspondingly, in these possible embodiments, a media content server 104-1 that implements logic to traverse media content directories of other media content servers 104 may send modified HTTP get requests that contain wildcard specification. For example, a first media content server 104-1 may send a modified HTTP get request that contains a wildcard specification of retrieving any URLs with a “.mp4” extension, e.g., “*.mp4” under the HTTP directory “content” of a second media content server 104-2. Upon receiving this modified HTTP get request, the second media content server 104-1 may retrieve all URLs underneath the HTTP directory “content” that have an extension of “.mp4”. The retrieved URLs may be placed in a HTTP response to the first media content server 104-1. Other kinds of URL patterns, for example, “.wav”, “.jpg”, etc., may be specified in a wildcard expression and retrieved in a similar manner.

### 2.12 Grouping Icons that Represent Media Content

In some possible embodiments, URLs for multiple pieces of the media content can be presented as informative icons in a user interface in the media-centric way (e.g., a thumbnail image of a publicity poster for one or more scenes of a movie). In some possible embodiments, the informative icons may be organized in groups. For example, music may be organized in one group while movies in another group. An informative icon may be clicked on (or tapped on, or acted by a suitable action with a pointing device) to generate a request for one or more URLs for the underlying media content that is associated with the informative icon. Thus, any of the media content in the unified media content directory can be accessed in an intuitive, consistent manner, even though underlying mechanisms for accessing the media content may differ (e.g., some may be streamed while others may be through the local reading of a media file).

### 2.13 Authentication and Digital Rights

In some possible embodiments where a domain registrar for the media content sharing domain keeps track of membership of the media content sharing domain, a media content network 102-1 may be authenticated in order to join the media content sharing domain. Similarly, a client or a user of a client may be authenticated in order to access a unified directory service provided by a media content network 102-1 or by a media content sharing domain. For example, some media content may be offered for pay and restricted to paying clients. Different consuming models (one-time use/rent, buy, limited/controlled access, previews only, etc.) may be supported by the media content sharing domain that implements the unified media content directory.

It should be noted that the unified media content directory is orthogonal to digital rights a client or a user of the client may be required in order to consume (e.g., play) the media content pointed to by the URLs in the unified media content directory. To put it differently, the unified media content directory provides a logical listing of URLs for the media content that may be accessed by a client. However, whether the client can actually consume the media content may still depend on whether the media content is restricted to holders of certain digital rights and whether the client holds these digital rights.

### 2.14 Load Balancing and High Availability

It should be noted that load conditions on individual media content servers might vary greatly and dynamically. Load conditions on other media content servers may be proactively and/or lazily monitored from service announcements, remote procedure calls, and/or other probing methods. In some possible embodiments, load conditions may be monitored based on a schedule. Such a schedule may be periodical, or adaptively changing. For example, monitoring by a media content server of another media content server may be more frequent when the other media content server's load condition varies more frequently. Conversely, the monitoring may be less frequent when the other media content server's load condition varies less frequently.

In some possible embodiments, when a piece of media content can be accessed through several media content servers, as previously noted, the least loaded one may be chosen to access the media content. It should be noted, however, that the present invention is not so limited. In some other possible embodiments, other ways of choosing one of multiple media content servers to access media content may be used. For example, instead of using the least loaded media content server, a media content server may be chosen for accessing the media content in round-robin, weighted round-robin, random, and/or based on other selection factors from the several media content servers.

It should be noted that the redundancy of a piece of media content could be used advantageously to provide high availability for accessing the piece of media content. For example, when a media content server that offers the piece of media content is out of service for whatever reason, a new one out of the remaining media content server(s) may be used to replace the failed media content server for the purpose of accessing the piece of media content. This may simply be accomplished by redirecting a request for the piece of media content to the new media content server using a new URL that was previously eliminated from the unified media content directory as a duplicate.

### 2.15 Example Media Content Server

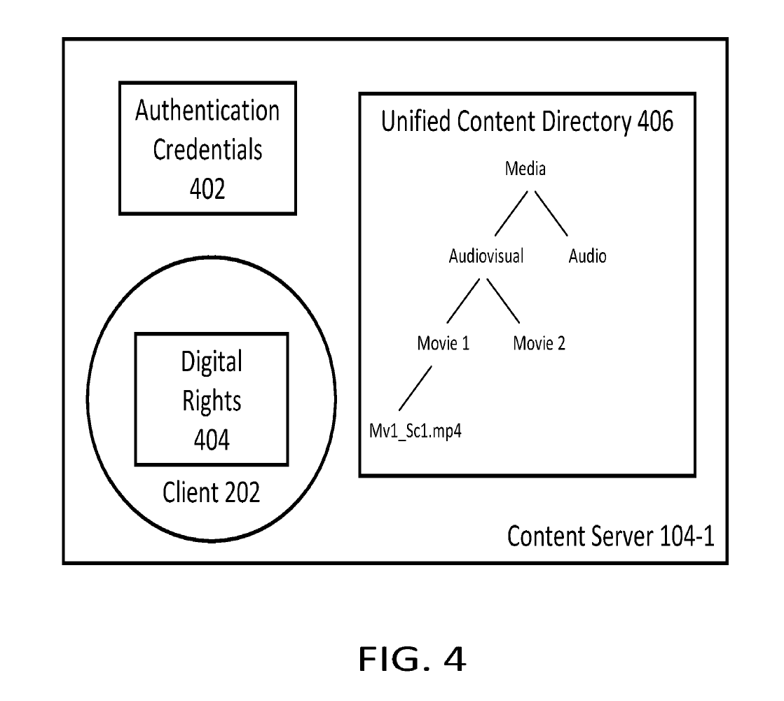

FIG. 4 illustrates an example media content server 104-1 according to a possible embodiment of the present invention. The media content server 104-1 comprises authentication credentials 402 that may be provided to another party for the purpose of authenticating the media content server 104-1. For example, a public certificate issued by a trusted authority may be stored in the domain credentials 402. When joining a media content network 102-1 or a media content sharing domain, the media content server 104-1 can provide the authentication credential 402 to other media content servers 104, or a gateway for the media content network 102-1, or a domain registrar for a media content sharing domain. The media content server 104-1 also comprises a unified media content directory 406 in which URLs of media content both local and remote have been reconfigured as local URLs accessible using the HTTP protocol. In some possible embodiments, this unified media content directory 406 may be, but is not limited to be, hierarchical as illustrated.

In some possible embodiments, a client 202 may be co-located with the media content server 104-1 or be a part of the media content server 104-1. This client 202 may possess a set of digital rights to enable the client 202 to consume one or more pieces of media content that require the digital rights.

### 2.16 Example Process Flow

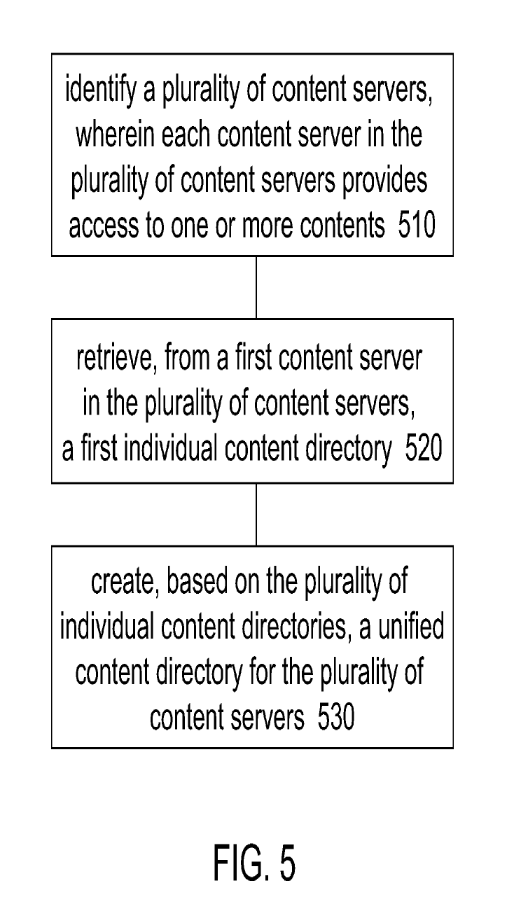

FIG. 5 illustrates an example process flow according to a possible embodiment of the present invention. In some possible embodiments, a media content server such as 104-1 of FIG. 2 and FIG. 3 may implement this process flow. In block 510, the media content server 104-1 identifies one or more media content servers that support a unified media content directory. To identify the plurality of media content servers, the media content server 104-1 may use a service discovery process such as DNS-SD, which allows the media content server 104-1 to receive one or more service announcement from the one or more media content servers.

Each media content server in the one or more media content servers provides access to one or more pieces of media content. In some possible embodiments, the one or more pieces of media content may be locally configured for access through a media content server in the one or more media content servers even without the unified media content directory service.

In block 520, the media content server 104-1 retrieves, from a first media content server (e.g., 104-2) of the one or more media content servers, a first individual media content directory. In some possible embodiments, the one or more media content servers belong to a single network domain such as an IP domain. The one or more media content servers may form a media content network (e.g., in the IP domain). Each of the one or more media content servers may run an HTTP server. The HTTP-based service provided by the HTTP server may be advertised in service announcements to other media content servers. Thus, using a suitable network protocol such as HTTP, the media content server 104-1 may retrieve individual media content directories from the media content servers (104-1 through 4 as illustrated) in the same media content network such as 102-1. For example, the media content server 104-1 may send one or more HTTP requests to the first media content server 104-2. In response to this request from the media content server 104-1, the first media content server 104-2 may send one or more HTTP responses to the media content server 104-1. The media content server 104-1 may receive these responses that contain information about the first individual media content directory.

In some possible embodiments, at least one of the HTTP requests, sent by the media content server 104-1 to the media content server 104-2, is an enhanced HTTP get request. This enhanced request may specify a wildcard expression to retrieve URLs of one or more pieces of media content that match the wildcard expression. Enhanced HTTP get requests may be used to browse the first individual media content directory, which for example, may have a hierarchical organization in which URLs of the one or more pieces of media content may be in any of two or more levels in the hierarchical organization.

The first individual media content directory is associated with the first media content server (104-2 in the present example) in the one or more media content servers 104. The first individual media content directory is one of one or more individual media content directories. Each media content server in the network 102-1 may have (or be associated with) a different individual media content directory.

In block 530, based on the one or more individual media content directories, the media content server 104-1 creates a unified media content directory for the one or more media content servers. Each URL in the unified media content directory refers to a distinct piece of media content. In some possible embodiments, at least one URL in the unified media content directory refers to a piece of audio media content. In some possible embodiments, at least one URL in the unified media content directory refers to a piece of video media content. In some possible embodiments, at least one URL in the unified media content directory refers to a piece of photographic media content. In some possible embodiments, at least one URL in the unified media content directory refers to a media file that contains metadata, which can be used to uniquely identify a piece of media content contained therein.

The unified media content directory provides a uniform way for a client to access any piece of media content referred to by the URLs in the unified media content directory. In some possible embodiments, the client may be co-located with a media content server in the one or more media content servers. In some possible embodiments, the client is on the same side of a firewall with at least one media content server in the one or more media content servers. In some possible embodiments, the client is on the other side of a firewall with at least one media content server in the one or more media content servers. However, the client can still access a piece of media content provided by the at least one media content server using a URL in the unified media content directory as if the client were on the same side of the firewall.

In some possible embodiments, the process flow of FIG. 5 may be performed by one or more computing devices (e.g., on the media content server 104-1).

In some possible embodiments, instead of being limited to the same network domain, the one or more media content servers may span over multiple network domains. Thus, some of the media content servers may be located in a network domain different from that of the media content server 104-1. In these possible embodiments, the one or more media content servers may still form a media content sharing domain, as previously discussed. Particularly, these multiple network domains may or may not be behind the same firewall. For example, some media content servers in the one or more media content servers may be behind a home-based network firewall, while some other media content servers in the one or more media content servers may be behind a corporate-based network firewall.

In some possible embodiments, once a unified media content directory is created on the media content server 104-1, a client may access a piece of media content referred to by a URL in the unified media content directory. In some possible embodiments, the media content server 104-1 may receive, from a client, a request to access a first piece of media content referred to by a first URL in the unified media content directory. This request may be based on the standard HTTP protocol, for example. Upon receiving the request, the media content server 104-1 may allow the client to access the first piece of media content. In some possible embodiments, to consume the first media content, the client may be required to present evidence of requisite digital rights.

In some possible embodiments, the first piece of media content can be accessed through more than one media content server in the one or more media content servers. In these possible embodiments, a load-balancing algorithm (least-loaded, round-robin, weighted round-robin, sequential, random, etc.) may be used to select a media content server among the more than one media content server. The selected media content server will be used to provide the first piece of media content to a requesting client. The media content server 104-1, for example, may implement logic which, when performed by one or more processors, determines a load condition for at least one media content server in the plurality of media content servers. The media content server 104-1, for example, may also implement policies, rules and algorithms for selecting a media content server from the one or more media content servers to serve the first piece of media content.

In some possible embodiments where the first piece of media content can be accessed through more than one media content server in the one or more media content servers, and where the first media content server is specified as the media content server to provide access to the first piece of media content, the media content server 104-1 may determine at some point in time that the first media content server is out of service or overloaded. In response to such a determination, the media content server 104-1 may replace the first media content server with a second media content server as the media content server to provide access to the first piece of media content.

In some possible embodiments, a system may comprise at least one processor and a computer readable storage medium comprising coded instructions which, when executed with the at least one processor, cause the system to perform at least one step of a method as recited above. In some possible embodiments, a system may comprise means for performing at least one step of a method as recited above.

In some possible embodiments, an integrated circuit (IC) device may be configured or programmed to perform steps of one or more of the methods that are recited above, or embody, dispose, or support one or more of the systems as recited above. In some possible embodiments, the IC may comprise at least one of a processor, a programmable logic device, a microcontroller, a field programmable gate array, or an application specific IC.

In some possible embodiments, the computer readable storage medium as mentioned above may configure or program at least one of the systems as recited above, or configure or program at least one of the IC devices as recited above.

### 3.0 Example Implementation Platforms

According to one possible embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

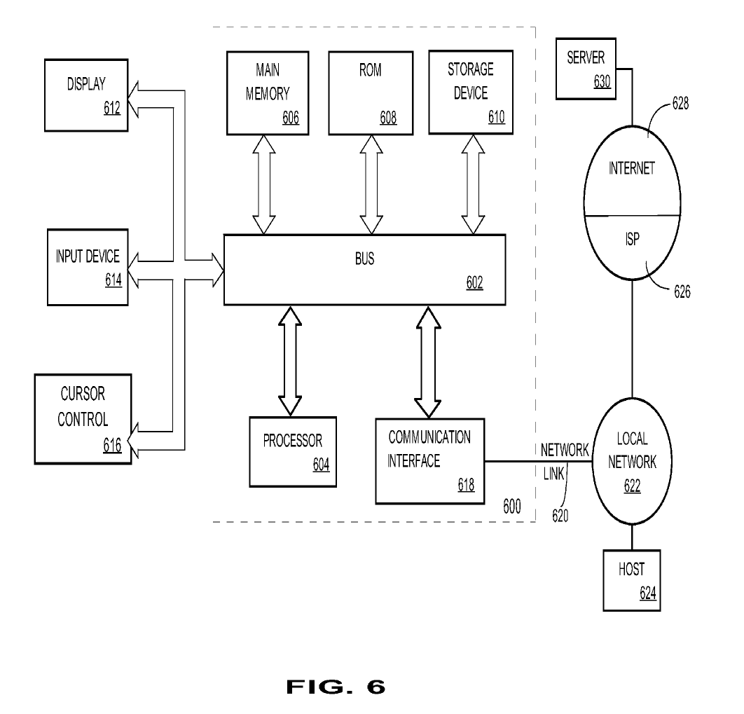

For example, FIG. 6 is a block diagram that illustrates a computer system 600 upon which a possible embodiment of the invention may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one possible embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative possible embodiments, hard-wired circuitry may be used in place of or in combination with software instructions.

The term “storage media” as used herein refers to any media that store data and/or instructions that cause a machine to operation in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 4.0 Enumerated Example Embodiments

Thus, embodiments of the present invention may relate to one or more of the enumerated example embodiments below, each of which are examples, and, as with any other related discussion provided above, should not be construed as limiting any claim or claims provided yet further below as they stand now or as later amended, replaced, or added. Likewise, these examples should not be considered as limiting with respect to any claim or claims of any related patents and/or patent applications (including any foreign or international counterpart applications and/or patents, divisionals, continuations, re-issues, etc.).

Enumerated example embodiment 1 is a method comprising: identifying one or more media content servers, each media content server in the one or more media content servers provides access to one or more pieces of media content; retrieving, from a first media content server in the one or more media content servers, a first individual media content directory, the first individual media content directory is associated with the first media content server in the one or more media content servers, and the first individual media content directory is one of one or more individual media content directories each associated with a media content server; and creating, based on the one or more individual media content directories, a unified media content directory for the one or more media content servers, each resource locator in the unified media content directory refers to a distinct piece of media content in the one or more pieces of media content.

Enumerated example embodiment 2 is a method as described in enumerated example embodiment 1, wherein a second individual media content directory in the one or more individual media content directories is associated with a second media content server in the one or more media content servers.

Enumerated example embodiment 3 is a method as described in enumerated example embodiment 1, wherein the one or more media content servers belong to a single network domain.

Enumerated example embodiment 4 is a method as described in enumerated example embodiment 1, wherein the one or more media content servers span over multiple network domains.

Enumerated example embodiment 5 is a method as described in enumerated example embodiment 1, further comprises: receiving, by a client, one or more resource locators in the unified media content directory; receiving, from the client, a request that contains a resource locator in the one or more resource locators; and sending, to the client, a first piece of media content, wherein the resource locator in the one or more resource locators refers to the first piece of media content.

Enumerated example embodiment 6 is a method as described in enumerated example embodiment 1, wherein a first piece of media content referred to by a resource locator in the unified media content directory is accessed through more than one media content server in the one or more media content servers.

Enumerated example embodiment 7 is a method as described in enumerated example embodiment 1, wherein at least one resource locator in the unified media content directory refers to a media file that contains metadata and wherein the metadata can be used to uniquely identify the at least one piece of media content.

Enumerated example embodiment 8 is a method as described in enumerated example embodiment 1, further comprises: receiving one or more service announcement from the one or more media content servers, wherein the one or more service announcement announce support for unified media content directory service by the one or more media content servers.

Enumerated example embodiment 9 is a method as described in enumerated example embodiment 1, wherein a client that uses the unified media content directory is co-located with a media content server in the one or more media content servers.

Enumerated example embodiment 10 is a method as described in enumerated example embodiment 1, wherein a client that uses the unified media content directory is located behind a firewall, and wherein at least one media content server in the one or more media content servers is located behind the firewall.

Enumerated example embodiment 11 is a method as described in enumerated example embodiment 1, wherein a client that uses the unified media content directory is located outside a firewall, wherein at least one media content server in the one or more media content servers is located behind the firewall, and wherein the client can access a piece of media content provided by the at least one media content server using a resource locator.

Enumerated example embodiment 12 is a method as described in enumerated example embodiment 1, wherein a first piece of media content in the unified media content directory are accessible through more than one media content server in the one or more media content servers, wherein the first media content server is specified as the media content server to provide access to the first piece of media content, and wherein the method further comprising, in response to a determination that the first media content server is out of service, determining a second media content server in the one or more media content servers to be specified as the media content server to provide access to the first piece of media content.

Enumerated example embodiment 13 is a method as described in enumerated example embodiment 1, further comprises determining a load condition for at least one media content server in the one or more media content servers.

Enumerated example embodiment 14 is a method as described in enumerated example embodiment 1, wherein at least one resource locator in the unified media content directory refers to one of (1) an audio file, (2) a video file, and (3) a digital photo file.

Enumerated example embodiment 15 is a system comprising: at least one processor; and a computer readable storage medium comprising encoded instructions which, when executed with the at least one processor, cause the system to perform: identifying one or more media content servers, each media content server in the one or more media content servers provides access to one or more pieces of media content; retrieving, from a first media content server in the one or more media content servers, a first individual media content directory, the first individual media content directory is associated with the first media content server in the one or more media content servers, and the first individual media content directory is one of one or more individual media content directories each associated with a media content server; and creating, based on the one or more individual media content directories, a unified media content directory for the one or more media content servers, each resource locator in the unified media content directory refers to a distinct piece of media content in the one or more pieces of media content.

Enumerated example embodiment 16 is an apparatus comprising: means for identifying one or more media content servers, each media content server in the one or more media content servers provides access to one or more pieces of media content; means for retrieving, from a first media content server in the one or more media content servers, a first individual media content directory, the first individual media content directory is associated with the first media content server in the one or more media content servers, and the first individual media content directory is one of one or more individual media content directories each associated with a media content server; and means for creating, based on the one or more individual media content directories, a unified media content directory for the one or more media content servers, each resource locator in the unified media content directory refers to a distinct piece of media content in the one or more pieces of media content.

Enumerated example embodiment 17 is a computer readable storage medium comprising encoded instructions which, when executed with one or more processors, cause the one or more processors to perform to perform a method as described in enumerated example embodiments 1-14 and 19-21.

Enumerated example embodiment 18 is a use for one or more of a computer, a system, or an apparatus performing one or more methods as described in enumerated example embodiments 1-14 and 19-21.

Enumerated example embodiment 19 is a method as described in enumerated example embodiment 1, further comprising: sending, by a second media content server, one or more HTTP requests to the first media content server; and receiving, by the second media content server from the first media content server, one or more HTTP responses from the first media content server that contain information about the first individual media content directory.

Enumerated example embodiment 20 is a method as described in enumerated example embodiment 19, wherein at least one of the HTTP requests is an enhanced HTTP get request that specifies a wildcard expression to retrieve resource locators from the unified media content directory that match the wildcard expression.

Enumerated example embodiment 21 is a method as described in enumerated example embodiment 1, wherein the first individual media content directory has a hierarchical organization in which URLs may be in any of two or more levels in the hierarchical organization.

Enumerated example embodiment 22 is a system as described in enumerated example embodiment 15, wherein a second individual media content directory in the one or more individual media content directories is associated with a second media content server in the one or more media content servers.

Enumerated example embodiment 23 is a system as described in enumerated example embodiment 15, wherein the one or more media content servers belong to a single network domain.

Enumerated example embodiment 24 is a system as described in enumerated example embodiment 15, wherein the one or more media content servers span over multiple network domains.

Enumerated example embodiment 25 is a system as described in enumerated example embodiment 15, further comprises: receiving, by a client, one or more resource locators in the unified media content directory; receiving, from the client, a request that contains a resource locator in the one or more resource locators; and sending, to the client, a first piece of media content, wherein the resource locator in the one or more resource locators refers to the first piece of media content.

Enumerated example embodiment 26 is a system as described in enumerated example embodiment 15, wherein a first piece of media content referred to by a resource locator in the unified media content directory is accessed through more than one media content server in the one or more media content servers.

Enumerated example embodiment 27 is a system as described in enumerated example embodiment 15, wherein at least one resource locator in the unified media content directory refers to a media file that contains metadata and wherein the metadata can be used to uniquely identify the at least one piece of media content.

Enumerated example embodiment 28 is a system as described in enumerated example embodiment 15, further comprises: receiving one or more service announcement from the one or more media content servers, wherein the one or more service announcement announce support for unified media content directory service by the one or more media content servers.

Enumerated example embodiment 29 is a system as described in enumerated example embodiment 15, wherein a client that uses the unified media content directory is co-located with a media content server in the one or more media content servers.

Enumerated example embodiment 30 is a system as described in enumerated example embodiment 15, wherein a client that uses the unified media content directory is located behind a firewall, and wherein at least one media content server in the one or more media content servers is located behind the firewall.

Enumerated example embodiment 31 is a system as described in enumerated example embodiment 15, wherein a client that uses the unified media content directory is located outside a firewall, wherein at least one media content server in the one or more media content servers is located behind the firewall, and wherein the client can access a piece of media content provided by the at least one media content server using a resource locator.

Enumerated example embodiment 32 is a system as described in enumerated example embodiment 15, wherein a first piece of media content in the unified media content directory are accessible through more than one media content server in the one or more media content servers, wherein the first media content server is specified as the media content server to provide access to the first piece of media content, and wherein the method further comprising, in response to a determination that the first media content server is out of service, determining a second media content server in the one or more media content servers to be specified as the media content server to provide access to the first piece of media content.

Enumerated example embodiment 33 is a system as described in enumerated example embodiment 15, further comprises determining a load condition for at least one media content server in the one or more media content servers.

Enumerated example embodiment 34 is a system as described in enumerated example embodiment 15, wherein at least one resource locator in the unified media content directory refers to one of (1) an audio file, (2) a video file, and (3) a digital photo file.

Enumerated example embodiment 35 is a system as described in enumerated example embodiment 15, further comprising: sending, by a second media content server, one or more HTTP requests to the first media content server; and receiving, by the second media content server from the first media content server, one or more HTTP responses from the first media content server that contain information about the first individual media content directory.

Enumerated example embodiment 36 is a system as described in enumerated example embodiment 35, wherein at least one of the HTTP requests is an enhanced HTTP get request that specifies a wildcard expression to retrieve resource locators from the unified media content directory that match the wildcard expression.

Enumerated example embodiment 37 is a system as described in enumerated example embodiment 35, wherein the first individual media content directory has a hierarchical organization in which URLs may be in any of two or more levels in the hierarchical organization.

Enumerated example embodiment 38 is an apparatus as described in enumerated example embodiment 16, wherein a second individual media content directory in the one or more individual media content directories is associated with a second media content server in the one or more media content servers.

Enumerated example embodiment 39 is an apparatus as described in enumerated example embodiment 16, wherein the one or more media content servers belong to a single network domain.

Enumerated example embodiment 40 is an apparatus as described in enumerated example embodiment 16, wherein the one or more media content servers span over multiple network domains.

Enumerated example embodiment 41 is an apparatus as described in enumerated example embodiment 16, further comprises: receiving, by a client, one or more resource locators in the unified media content directory; receiving, from the client, a request that contains a resource locator in the one or more resource locators; and sending, to the client, a first piece of media content, wherein the resource locator in the one or more resource locators refers to the first piece of media content.

Enumerated example embodiment 42 is an apparatus as described in enumerated example embodiment 16, wherein a first piece of media content referred to by a resource locator in the unified media content directory is accessed through more than one media content server in the one or more media content servers.

Enumerated example embodiment 43 is an apparatus as described in enumerated example embodiment 16, wherein at least one resource locator in the unified media content directory refers to a media file that contains metadata and wherein the metadata can be used to uniquely identify the at least one piece of media content.

Enumerated example embodiment 44 is an apparatus as described in enumerated example embodiment 16, further comprises: receiving one or more service announcement from the one or more media content servers, wherein the one or more service announcement announce support for unified media content directory service by the one or more media content servers.

Enumerated example embodiment 45 is an apparatus as described in enumerated example embodiment 16, wherein a client that uses the unified media content directory is co-located with a media content server in the one or more media content servers.

Enumerated example embodiment 46 is an apparatus as described in enumerated example embodiment 16, wherein a client that uses the unified media content directory is located behind a firewall, and wherein at least one media content server in the one or more media content servers is located behind the firewall.

Enumerated example embodiment 47 is an apparatus as described in enumerated example embodiment 16, wherein a client that uses the unified media content directory is located outside a firewall, wherein at least one media content server in the one or more media content servers is located behind the firewall, and wherein the client can access a piece of media content provided by the at least one media content server using a resource locator.

Enumerated example embodiment 48 is an apparatus as described in enumerated example embodiment 16, wherein a first piece of media content in the unified media content directory are accessible through more than one media content server in the one or more media content servers, wherein the first media content server is specified as the media content server to provide access to the first piece of media content, and wherein the method further comprising, in response to a determination that the first media content server is out of service, determining a second media content server in the one or more media content servers to be specified as the media content server to provide access to the first piece of media content.

Enumerated example embodiment 49 is an apparatus as described in enumerated example embodiment 16, further comprises determining a load condition for at least one media content server in the one or more media content servers.

Enumerated example embodiment 50 is an apparatus as described in enumerated example embodiment 16, wherein at least one resource locator in the unified media content directory refers to one of (1) an audio file, (2) a video file, and (3) a digital photo file.

Enumerated example embodiment 51 is an apparatus as described in enumerated example embodiment 16, further comprising: sending, by a second media content server, one or more HTTP requests to the first media content server; and receiving, by the second media content server from the first media content server, one or more HTTP responses from the first media content server that contain information about the first individual media content directory.

Enumerated example embodiment 52 is an apparatus as described in enumerated example embodiment 51, wherein at least one of the HTTP requests is an enhanced HTTP get request that specifies a wildcard expression to retrieve resource locators from the unified media content directory that match the wildcard expression.

Enumerated example embodiment 53 is an apparatus as described in enumerated example embodiment 16, wherein the first individual media content directory has a hierarchical organization in which URLs may be in any of two or more levels in the hierarchical organization.

### 5.0 Equivalents, Extensions, Alternatives and Miscellaneous

In the foregoing specification, possible embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method, comprising:
identifying one or more media content servers, each media content server in the one or more media content servers providing access to one or more pieces of media content;
retrieving, from a first media content server in the one or more media content servers, a first individual media content directory, wherein the first individual media content directory is associated with the first media content server in the one or more media content servers, and wherein the first individual media content directory is one of one or more individual media content directories each associated with a media content server; and
creating, based on the one or more individual media content directories, a unified media content directory for the one or more media content servers, each resource locator in the unified media content directory referring to a distinct piece of media content in the one or more pieces of media content.

2. The method as recited in claim 1, wherein a second individual media content directory in the one or more individual media content directories is associated with a second media content server in the one or more media content servers.

3. The method as recited in claim 1, wherein the one or more media content servers belong to a single network domain.

4. The method as recited in claim 1, wherein the one or more media content servers span over multiple network domains.

5. The method as recited in claim 1, further comprising:
receiving, by a client, one or more resource locators in the unified media content directory;
receiving, from the client, a request that contains a resource locator in the one or more resource locators; and
sending, to the client, a first piece of media content, wherein the resource locator in the one or more resource locators refers to the first piece of media content.

6. The method as recited in claim 1, wherein a first piece of media content referred to by a resource locator in the unified media content directory is accessed through more than one media content server in the one or more media content servers.

7. The method as recited in claim 1, wherein at least one resource locator in the unified media content directory refers to a media file that contains metadata and wherein the metadata can be used to uniquely identify the at least one piece of media content.

8. The method as recited in claim 1, further comprising:
receiving one or more service announcement from the one or more media content servers, wherein the one or more service announcement announce support for unified media content directory service by the one or more media content servers.

9. The method as recited in claim 1, wherein a client that uses the unified media content directory is co-located with a media content server in the one or more media content servers.

10. The method as recited in claim 1, wherein a client that uses the unified media content directory is located behind a firewall, and wherein at least one media content server in the one or more media content servers is located behind the firewall.

11. The method as recited in claim 1, wherein a client that uses the unified media content directory is located outside a firewall, wherein at least one media content server in the one or more media content servers is located behind the firewall, and wherein the client can access a piece of media content provided by the at least one media content server using a resource locator.

12. The method as recited in claim 1, further comprising:
sending, by a second media content server, one or more HTTP requests to the first media content server; and
receiving, by the second media content server from the first media content server, one or more HTTP responses from the first media content server that contain information about the first individual media content directory.

13. The method as recited in claim 12, wherein at least one of the HTTP requests is an enhanced HTTP get request that specifies a wildcard expression to retrieve resource locators from the unified media content directory that match the wildcard expression.

14. The method as recited in claim 1, wherein the first individual media content directory has a hierarchical organization in which URLs may be in any of two or more levels in the hierarchical organization.

15. The method as recited in claim 1, wherein a first piece of media content in the unified media content directory is accessible through more than one media content server in the one or more media content servers, wherein the first media content server is specified as the media content server to provide access to the first piece of media content, and wherein the method further comprises, in response to a determination that the first media content server is out of service, determining a second media content server in the one or more media content servers to be specified as the media content server to provide access to the first piece of media content.

16. The method as recited in claim 1, further comprising determining a load condition for at least one media content server in the one or more media content servers.

17. The method as recited in claim 1, wherein at least one resource locator in the unified media content directory refers to an audio file.

18. The method as recited in claim 1, wherein at least one resource locator in the unified media content directory refers to a video file.

19. The method as recited in claim 1, wherein at least one resource locator in the unified media content directory refers to a digital photo file.

20. A computer readable storage medium comprising encoded instructions encoded tangibly therewith which, when executed with one or more processors, cause the one or more processors to perform a process that comprises:
identifying one or more media content servers, each media content server in the one or more media content servers provides access to one or more pieces of media content;
retrieving, from a first media content server in the one or more media content servers, a first individual media content directory, wherein the first individual media content directory is associated with the first media content server in the one or more media content servers, and wherein the first individual media content directory comprises one of one or more individual media content directories;
and
creating, based on the one or more individual media content directories, a unified media content directory for the one or more media content servers, each resource locator in the unified media content directory referring to a distinct piece of media content in the one or more pieces of media content.
